(19) United States
(12) Patent Application Publication
(10) Pub. No.: US 2026/0219380 A1
(43) Pub. Date: Jul. 30, 2026

(54) COORDINATED FREQUENCY MODULATED CONTINUOUS WAVE RADAR CO-EXISTENCE WITH ARTIFICIAL WAVEFORM PHASE RAMPS

(71) Applicant: QUALCOMM Incorporated, San Diego, CA (US)

(72) Inventors: Stelios STEFANATOS, San Diego, CA (US); Kapil GULATI, Belle Mead, NJ (US); Junyi LI, Fairless Hills, PA (US)

(21) Appl. No.: 19/145,704

(22) PCT Filed: Feb. 22, 2024
(86) PCT No.: PCT/US2024/016936

§ 371 Date: Jul. 3, 2025

(30) Foreign Application Priority Data
Mar. 10, 2023 (GR) 20230100209

(51) Int. Cl. G01S 13/58; G01S 13/34; G01S 13/931

(52) U.S. Cl. CPC G01S 13/584; G01S 13/343; G01S 13/931

(57) ABSTRACT

The present disclosure provides methods and systems for radar detection with coordinated interference using artificially introduced phase ramps. A radar device transmits a frequency-modulated continuous-wave (FMCW) radar waveform having an artificially introduced phase ramp over multiple chirps within each frame of a plurality of frames The radar device receives signals including reflections of the FMCW radar waveform. The radar device calculates a respective range and a respective velocity of the one or more detected objects based on a phase of chirps in the received signals. The radar device attempts to associate each of the one or more detected objects with a track based on the respective range and the respective velocity. The radar device drops one or more detected objects or a corresponding track in response to a velocity change between frames for the detected object being greater than a threshold.

### CROSS-REFERENCE TO RELATED APPLICATIONS

This application claims the benefit of Greek application No. 202340100209 titled “COORDINATED FREQUENCY MODULATED CONTINUOUS WAVE RADAR CO-EXISTENCE WITH ARTIFICIAL WAVEFORM PHASE RAMPS,” filed Mar. 10, 2023, which is incorporated herein by reference in its entirety.

### BACKGROUND

Aspects of the present disclosure relate generally to radar, and more particularly, to frequency-modulated continuous-wave (FMCW) radar waveforms for radars.

FMCW radar is used in the vehicle context to detect objects surrounding the vehicle. An FMCW transmit radar waveform includes multiple frames, each frame including multiple chirps. If a target is present, the FMCW radar waveform will return to the radar after a propagation delay based on the range and the speed of light. Accordingly, the radar may determine the range to an object based on the measured propagation delay and simple signal processing. Further, the radar may track detections over multiple frames. Combining the successive frame detections results in a time series of detections that are input into a data-association and track-detection filter. In the case of a single target, the filter smoothens out the detections from noise impairments and creates a clean trajectory or track of the target. In the case of multiple targets, the filter can associate each target with a track and add or drop detections based on a respective association with a track.

In the vehicle context, interference to the FMCW radar from other FMCW radars on other vehicles is possible, especially as more vehicles are equipped with radars, for example, for self-driving operation. In scenarios where multiple radars operate over the same frequency, a signal transmitted from a first radar will be received by a nearby second radar. This direct signal from the first radar may result in the second (“victim”) radar experiencing increased noise floor (rendering target detection less reliable) and detecting “ghost” targets, e.g., targets that do not actually exist in the detected location (also called “false alarms”). Both of these effects are undesirable. Thus, improvements in radar detection in the presence of interfering signals may be desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, the present disclosure includes a method of radar detection. The method may include transmitting a frequency-modulated continuous-wave (FMCW) radar waveform having an artificially introduced phase ramp over multiple chirps within each frame of a plurality of frames. The method may include receiving signals including reflections of the FMCW radar waveform. The method may include calculating a respective range of one or more detected objects based on a timing of the received signals. The method may include calculating a respective velocity of the one or more detected objects based on a phase of chirps in the received signals. The method may include attempting to associate each of the one or more detected objects with a track based on the respective range and the respective velocity. The method may include dropping one or more detected objects or the track for a false detected object of the one or more detected objects in response to a velocity change between frames for the detected object being greater than a threshold.

In another aspect, the disclosure provides a radar including one or more antennas, a memory storing executable instructions, and at least one processor communicatively coupled with the plurality of antennas and with the memory. The at least one processor may be configured to transmit, via the one or more antennas, a FMCW radar waveform having an artificially introduced phase ramp over multiple chirps within each frame of a plurality of frames. The at least one processor may be configured to receive, via the one or more antennas, signals including reflections of the FMCW radar waveform. The at least one processor may be configured to calculate a respective range of one or more detected objects based on a timing of the received signals. The at least one processor may be configured to calculate a respective velocity of the one or more detected objects based on a phase of chirps in the received signals. The at least one processor may be configured to attempt to associate each of the one or more detected objects with a track based on the respective range and the respective velocity. The at least one processor may be configured to drop one or more detected objects or the track for a false detected object of the one or more detected objects in response to a velocity change between frames for the detected object being greater than a threshold.

In another aspect, the disclosure provides a radar including means for transmitting a FMCW radar waveform having an artificially introduced phase ramp over multiple chirps within each frame of a plurality of frames. The radar includes means for receiving signals including reflections of the FMCW radar waveform. The radar includes means for calculating a respective range of one or more detected objects based on a timing of the received signals. The radar includes means for calculating a respective velocity of the one or more detected objects based on a phase of chirps in the received signals. The radar includes means for attempting to associate each of the one or more detected objects with a track based on the respective range and the respective velocity. The radar includes means for dropping one or more detected objects or the track for a false detected object of the one or more detected objects in response to a velocity change between frames for the detected object being greater than a threshold.

In another aspect, the disclosure provides a computer-readable medium storing instructions executable by a processor of a radar device. The computer-readable medium includes code to transmit a frequency-modulated continuous-wave (FMCW) radar waveform having an artificially introduced phase ramp over multiple chirps within each frame of a plurality of frames. The computer-readable medium includes code to receive signals including reflections of the FMCW radar waveform. The computer-readable medium includes code to calculate a respective range of one or more detected objects based on a timing of the received signals. The computer-readable medium includes code to calculate a respective velocity of the one or more detected objects based on a phase of chirps in the received signals. The computer-readable medium includes code to attempt to associate each of the one or more detected objects with a track based on the respective range and the respective velocity. The computer-readable medium includes code to drop one or more detected objects or the track for a false detected object of the one or more detected objects in response to a velocity change between frames for the detected object being greater than a threshold.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic diagram of an example operating environment of a radar device that detects objects.

FIG. 2 is a conceptual diagram of an example of a frequency-modulated continuous wave (FMCW) waveform.

FIG. 3 is a conceptual diagram showing examples of a transmitted FMCW signal and a corresponding returned FMCW signal.

FIG. 4 is a diagram showing examples of FMCW signals with artificially introduced phase ramps.

FIG. 5 is a schematic diagram of an example of signal processing for a received FMCW signal.

FIG. 6 is a flow diagram showing an example of a method of radar detection.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details. Additionally, the term “component” as used herein may be one of the parts that make up a system, may be hardware, firmware, and/or software stored on a computer-readable medium, and may be divided into other components.

The present disclosure generally relates to radar sensors, and in particular to radar sensors using frequency-modulated continuous-wave (FMCW) radar waveforms. A radar system may detect and track multiple targets located in an operating environment of the radar system.

More specifically, the disclosure addresses at least a problem relating to interference between multiple FMCW radars operating in an environment such that signals transmitted by a first radar are received as interference at a second radar.

Various techniques for signal processing have been proposed for either discarding observed samples contaminated by interference or identifying the portion of the received energy due to interference and cancelling out the interference. In conditions with a large number of interferers, the sample-discarding approach may not be feasible because there is a high probability that most or all of the samples will be contaminated by interference. The interference cancellation approach may be computationally intensive and may only handle a limited number of interferers. Additionally, these approaches may not be backwards compatible with radars currently in use.

In an aspect, the present disclosure provides for interference mitigation using a combination of coordinated interference and waveform shaping that allows ghost targets to be identified using simple signal processing. Coordinated interference may refer to using the same FMCW parameters at multiple radars including interfering radars. The coordinated interference may cause interfering signals to appear as if the interfering signals were returned signals such that the interfering signals are detected as potential targets (“ghost” targets). The waveform shaping may include adding an artificial phase ramp to a transmitted signal. The artificial phase ramp varies between successive frames (i.e., changes) and causes the waveform to appear as an object moving with a rapidly changing velocity when received as an interfering signal. That is, each radar may effectively add an artificial velocity shift in each frame that changes between frames. The signal processing may include conventional association and tracking filters. When the interfering signal includes an artificial phase ramp, the velocity of the potential detection may appear to change between frames in a manner that is unrealistic for an actual physical object. Accordingly, the detections due to interfering signals with artificial phase ramps may be dropped by the association and tracking filters. For example, the detections may not establish a track, or an established track may be dropped. In contrast, the artificial phase ramp of a returned signal may be cancelled out during a mixing operation with the transmitted signal such that a true velocity of the target is measured. Accordingly, the association and tracking filter may track actual objects that reflect the returned signals.

In an aspect, the present disclosure improves the performance of the radar by dropping detections of interfering signals that result in ghost targets. The radar continues to track detections based on returned signals from actual targets. Additionally, because detections based on the transmitted FMCW signal including the artificial phase ramps will be dropped by the association and tracking filter, the radar of the present disclosure is backward compatible with currently deployed FMCW radars.

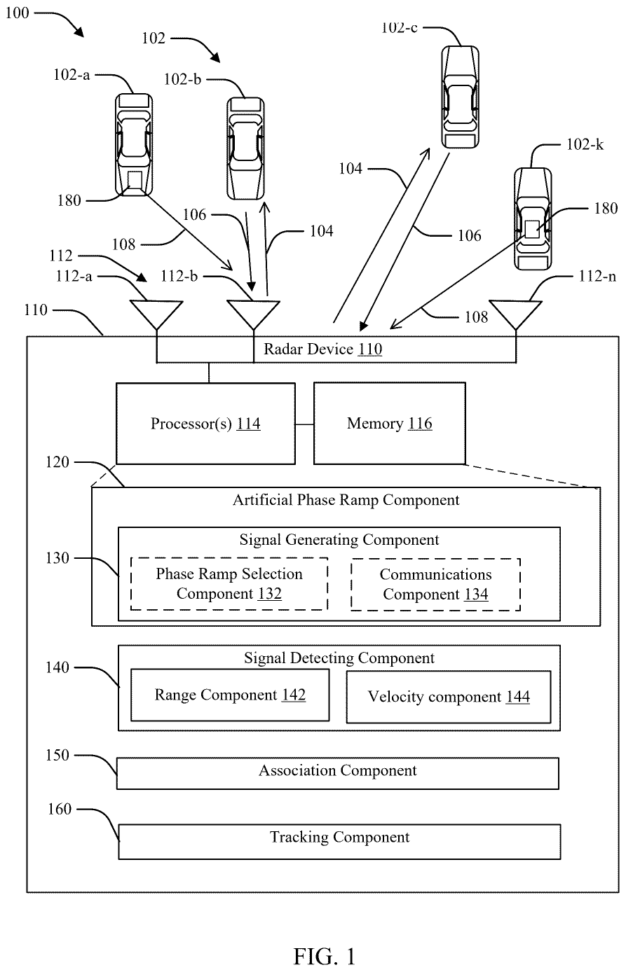

Additional features of the present aspects are described in more detail below with respect to FIGS. 1-6. The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

FIG. 1 illustrates an example operational scenario 100 for a radar device 110. In an aspect, the radar device 110 may be used in an automotive scenario to track surrounding objects 102 such as other vehicles. The objects 102 may be designated herein as objects 102-a, 102-b, 102-c, . . . 102-k, where k is a number of trackable objects. The radar device 110, however, may be utilized in other scenarios where tracking of multiple objects is desired, e.g., aircraft, drones, or robotics.

The radar device 110 may include one or more antennas 112, which may be designated herein as antennas 112-a, 112-b, . . . 112-n, where n is the total number of antennas. Generally, the radar device 110 may transmit a FMCW radar beam 104 having an artificial phase ramp via a first set of antennas 112. The radar beam 104 may reflect off the objects 102, and the radar device 110 may receive the reflected radar signals 106 via a different second set of the antennas 112. The radar device 110 may also receive interfering radar signals 108, which may be generated by radars at the objects 102 (e.g., other vehicles). In an aspect, the interfering radar signals 108 may also be FMCW radar beams with artificial phase ramps that are different than the artificial phase ramps of the radar beam 104. The radar device 110 may analyze the reflected radar signals 106 and the interfering radar signals 108 to detect and track the objects 102 while dropping tracks of ghost targets based on detections of the interfering radar signals 108.

The radar device 110 may include a processor 114 that executes instructions stored in memory 116. For example, the processor 114 may execute an operating system and/or one or more applications, which may include an artificial phase ramp component 120. The processor 114 may be communicatively coupled with one or more of the antennas 112 and with the memory 116.

The memory 116 may be configured for storing data and/or computer-executable instructions defining and/or associated with the artificial phase ramp component 120, and processor 114 may execute the artificial phase ramp component 120. Memory 116 may represent one or more hardware memory devices accessible to radar device 110. An example of memory 116 can include, but is not limited to, a type of memory usable by a computer, such as random access memory (RAM), read only memory (ROM), tapes, magnetic discs, optical discs, volatile memory, non-volatile memory, and any combination thereof. Memory 116 may store local versions of applications being executed by processor 114. In an implementation, the memory 116 may include a storage device, which may be a non-volatile memory.

The processor 114 may include one or more processors for executing instructions. An example of processor 114 can include, but is not limited to, any processor specially programmed as described herein, including a controller, microcontroller, application specific integrated circuit (ASIC), field programmable gate array (FPGA), system on chip (SoC), or other programmable logic or state machine. The processor 114 may include other processing components such as an arithmetic logic unit (ALU), registers, and a control unit. The processor 114 may include multiple cores and may be able to process different sets of instructions and/or data concurrently using the multiple cores to execute multiple threads.

The radar device 110 may include an artificial phase ramp component 120 that generates a FMCW waveform including an artificial phase ramp. Generally, the FMCW waveform has the same parameters as the FMCW waveforms transmitted by the potential interfering radars. For example, the FMCW waveform of the beam 104 may use the same carrier frequency, chirp duration, and chirp bandwidth as the potential interfering radars. Further, the radar device 110 may be synchronized with other potentially interfering radars to concurrently transmit the FMCW waveform. The artificial phase ramp of the FMCW waveform for the radar device 110 may be different than the phase ramp applied by the potential interfering radars. For example, the artificial phase ramp may be randomly generated or selected from a codebook. The artificial phase ramp may change every frame.

Conceptually, the artificial phase ramp may be viewed as an artificial velocity shift introduced to the transmitted FMCW waveform. In an aspect, where an FMCW radar waveform has no artificial phase ramp, an FMCW radar may detect a relative velocity between the radar and an object 102 based on a naturally formed phase ramp of a reflected radar signal 106. The naturally formed phase ramp of the reflected radar signal 106 may be due to the Doppler Effect, which applied to an FMCW waveform, appears as a linear increase of the phase of the chirps. When an FMCW radar waveform has an artificial phase ramp, a mixing operation on the FMCW radar waveform and the reflected radar signal 106 may cancel out the artificial phase ramp of the reflected radar signal 106, leaving the naturally formed phase ramp due to the Doppler shift, and the FMCW radar may still detect the relative velocity of the object 102. When the FMCW radar receives an interfering signal 108 including a second artificial phase ramp, the detected relative velocity will be based on the first artificial phase ramp transmitted by the radar, the second artificial phase ramp, and any naturally formed phase ramp due to a non-zero actual relative velocity between the radar and the interfering radar. The artificial phase ramps may be designed such that the detected relative velocity based on the interfering signal will vary greatly between successive frames.

The artificial phase ramp component 120 may include a signal generating component 130 configured to transmit a FMCW radar waveform having an artificially introduced phase ramp over multiple chirps within each frame of a plurality of frames. The signal generating component 130 may optionally include a phase ramp selection component 132 configured to set the artificially introduced phase ramp based on the velocity shift for the radar. The signal generating component 130 may optionally include a communications component 134 configured to coordinate transmission of the FMCW radar waveform with other devices. For example, communications component 134 may synchronize the radars and/or receive a phase ramp pattern.

The radar device 110 may include a signal detecting component 140 configured to detect a respective range and a respective velocity for one or more objects based on received signals. For example, the artificial phase ramp component 120 may include a range component 142 configured to calculate a respective range of one or more detected objects based on a timing of the received signals. As another example, the artificial phase ramp component 120 may include a velocity component 144 configured to calculate a respective velocity of the one or more detected objects based on a phase of chirps in the received signals.

The radar device 110 may include an association component 150 configured to associate each of the one or more detected objects with a track based on the respective range and the respective velocity.

The radar device 110 may include a tracking component 160 configured to drop the track for a false detected object of the one or more detected objects in response to a velocity change between frames for the false detected object being greater than a threshold.

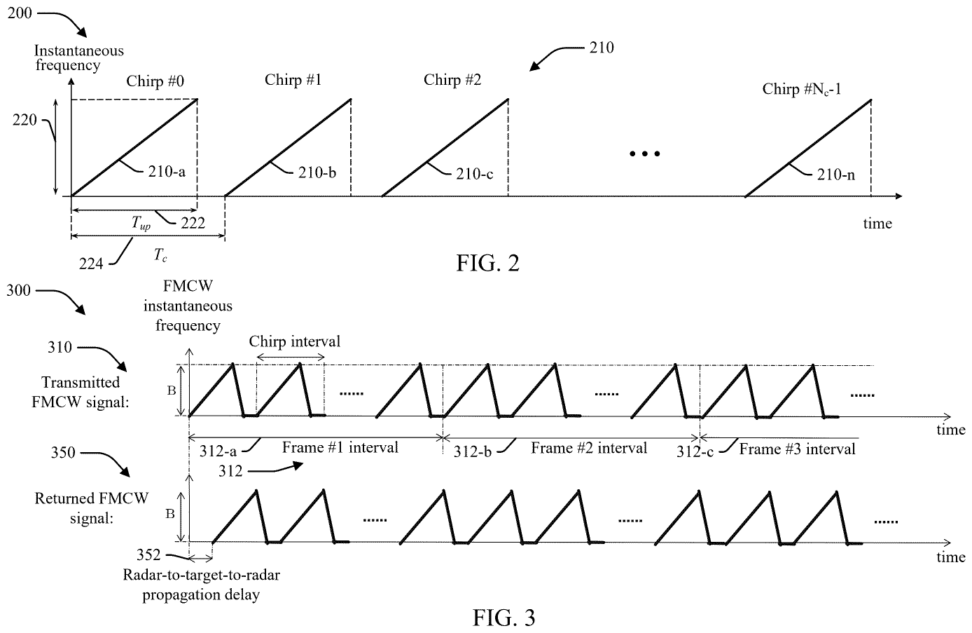

FIG. 2 illustrates an example FMCW waveform 200 including a plurality of chirps 210 (e.g., chirps 210-a, 210-b, 210-c, and 210-n). Each chirp 210 may include a signal that increases linearly in frequency over a bandwidth (B) 220 during an upchirp duration (Tᵤₚ) 222. Each chirp 210 may also be associated with a chirp period (T_{c}) 224 between the start of each chirp 210. The bandwidth 220 may start at a carrier frequency (f_{c}). A chirp may be mathematically represented according to equation (1):

$$x ( t ) = c \times {e}^{i 2 π {f}_{c} t} {e}^{i 2 π ( \frac{B}{{T}_{up}} ) {t}^{2}} , 0 \leq t \leq {T}_{up} \qquad ( 1 )$$

where cis a constant complex scalar that captures aspects such as phase locked loop (PLL) phase. A single frame waveform can be represented as:

$${\sum }_{m = 0 , … , {N}_{c} - 1} {x}_{m} ( t ) , 0 \leq t \leq {N}_{c} {T}_{c} \qquad ( 2 )$$

where xₘ(t):=x(t-mT_{c}) is the m-th chirp within the frame and T_{c}≥Tᵤₚ is the chirp transmission period.

FIG. 3 is a diagram 300 showing an example transmitted FMCW signal 310 and returned FMCW signal 350. The FMCW signal 310 may follow the FMCW waveform 200 in each frame 312 (e.g., frames 312-a, 312-b, and 312-c). The returned FMCW signal 350 may have the same FMCW waveform 200, but may be delayed by a radar-to-target-to-radar propagation delay (τ) 352. The range component 142 may calculate a range of an object 102 that reflected the returned FMCW signal 350 based on the propagation delay 352. The range component 142 may use the equation:

$$τ = \frac{2 d}{{c}_{0}} \qquad ( 3 )$$

where d is the distance (range) of the target from the radar and co is the speed of light.

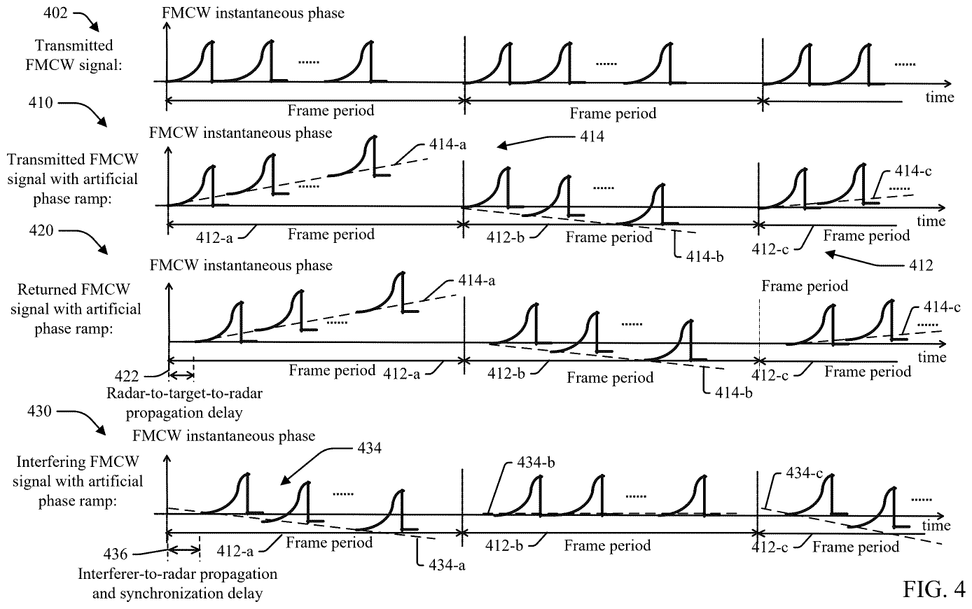

FIG. 4 is a diagram of the FMCW instantaneous phase of example signals 410, 420, and 430 including artificial phase ramps. A chart of the FMCW instantaneous phase 402 of the transmitted FMCW signal 310 (FIG. 3) is included for reference. The transmitted FMCW signal 310 may be represented mathematically for the m-th chirp waveform as:

$${x}_{m} ( t ) = c \times {e}^{i 2 π {f}_{c} ( t - {mT}_{c} )} {e}^{i 2 π ( \frac{B}{{T}_{up}} ) {( t - {mT}_{c} )}^{2}} , \qquad ( 4 )$$

where mT_{c}≤mT_{c}+Tᵤₚ, m=0, 1, . . . , N_{c}−1.

The transmitted FMCW signal 410 includes an artificial phase ramp 414 that varies between frames 412. For example, in a first frame 412-a, the phase of each chirp increases according to a slope of the phase ramp 414-a (e.g., in a similar manner as a relative velocity toward the radar). In contrast, in the second frame 412-b, the phase of each chirp decreases according to a slope of the phase ramp 414-b (e.g., in a similar manner as a relative velocity away from the radar). Once again in the third frame 412-c, the phase of each chirp increases according to a slope of the phase ramp 414-c.

The transmitted FMCW signal 410 may be represented mathematically for the m-th chirp waveform as:

$${x}_{m} ( t ) = {e}^{i {ϕ}_{m}} \times c \times {e}^{i 2 π {f}_{c} ( t - {mT}_{c} )} {e}^{i 2 π ( \frac{B}{{T}_{up}} ) {( t - {mT}_{c} )}^{2}} \qquad ( 5 )$$

where φₘ is an artificially introduced phase to the m-th chirp and π and e are the known constants. The sequence {φ₀, φ₁, . . . , φ_{N}_{_{c}}₋₁} applied to each chirp in the frame may be linearly increasing or decreasing to result in a phase ramp. For example, in the first frame 412-a, the sequence {φ₀, φ₁, . . . , φ_{N}_{_{c}}₋₁} may be increasing, while in the second frame 412-b the sequence {φ₀, φ₁, . . . , φ_{N}_{_{c}}₋₁} may be decreasing.

The sequence {φ_{0,i}, φ_{1,i}> . . . , φ_{N}_{_{c}}_{-1,}i} may be expressed mathematically for an i-th frame. For example, the phase ramp sequence may be selected as:

$${ϕ}_{m , i} = \frac{2 π {f}_{c} {T}_{c} {\tilde{v}}_{i} m}{{c}_{0}} , m = 0 , 1 , … , {N}_{c} - 1 , \qquad ( 6 )$$

where f_{c} is the carrier frequency, T_{c} is the chirp period within the frame, co is the speed of light, \tilde{v}ᵢ is a velocity shift for the i-th frame, and π is the known constant. The velocity shift \tilde{v}ᵢ is a parameter that specifies the phase ramp of the frame. The other parameters may be constants or set based on the common FMCW configuration for coordinated interference. The parameter \tilde{v}ᵢ can take arbitrary (positive or negative) values.

The returned FMCW signal 420 (e.g., reflected from a relatively stationary object) includes the same artificial phase ramp as the transmitted FMCW signal 410. The chirps are delayed by a radar-to-target-to-radar propagation delay 422, which is similar to the propagation delay 352 discussed above. Accordingly, the range of the object can be calculated based on the propagation delay 422.

The interfering FMCW signal 430 may be generated by another radar including an artificial phase ramp component 120. The artificial phase ramp 434 of the interfering FMCW signal 430 is different than the phase ramp 414 of the transmitted FMCW signal 410 in each frame. For example, in the first frame 412-a, the phase ramp 434-a of each chirp decreases, while in the second frame 412-b the phase ramp 434-b in each chirp remains constant, and in the third frame 412-c the phase ramp 434-c in each chirp decreases at a different slope than in the first frame 412-a. Additionally, the interfering FMCW signal 430 is associated with an interferer-to-radar propagation and synchronization delay 436. The propagation and synchronization delay 436 may be based on the range of the interferer as well as a timing difference between the radar and the interferer. Accordingly, determining a range based on the propagation and synchronization delay 436 may result in a range that does not correspond to an actual distance to the interferer (i.e., a ghost target).

In some implementations, the transmitted FMCW signal 410 and the interfering FMCW signal 430 may be synchronized. Although the disclosed techniques may operate without synchronization, an interfering FMCW signal 430 may be more likely to be correctly identified as a ghost target rather than noise when synchronized. The synchronization does not need to be exact, but the radars should transmit concurrently such that the interfering radar arrives within a same time window as the returned signals. For example, the interfering radars may start their frames close enough to ensure that the first chip interfering frame is received at the victim radar any time within the interval when the first chip of the victim radar frame is transmitted. In some implementations, the radars can achieve synchronization based on a common reference time (e.g., based on a global navigation satellite system (GNSS) such as the global positioning system (GPS). As another example, the radars can synchronize via direct communication protocols such as V2X.

In an aspect, in order to allow other radars to filter out interfering signals (e.g., interfering FMCW signal 430), each FMCW radar should select a different velocity shift for each frame. Several schemes may be used to select the velocity shift of any frame. For example, in a first option, the phase ramp selection component 132 may choose the velocity shift D; of any frame i randomly and independently of anything else. The randomly selected velocity shift for the interfering signal 430 may result in ghost targets appearing to have random velocities per frame that hop over the range of detected velocities at the victim radar. Such random velocities may be rejected by the association/tracking filter as noise artifacts. As another example, each radar may choose a deterministic pattern for the velocity shifts out of a system-wide applied codebook. The codebook may be distributed via a standards specification or government regulation. The phase ramp selection component 132 may select a pattern from the codebook randomly. Use of a codebook may prevent the possibility of a randomly selected velocities appearing similar to realistic movement. As another example, the FMCW radars (e.g., via communications component 134) may communicate via a radio network to assign a codebook pattern to each FMCW radar. For example, a network entity such as a road side unit (RSU) or base station may signal the assigned codebook pattern via signaling such as radio resource control (RRC) messages, media access control (MAC) control element (CE), physical downlink control channel (PDCCH), or physical downlink shared channel (PDSCH). In another example, the FMCW radars may use direct link communications such as vehicle to anything (V2X) signaling to ensure that no two radars use the same pattern.

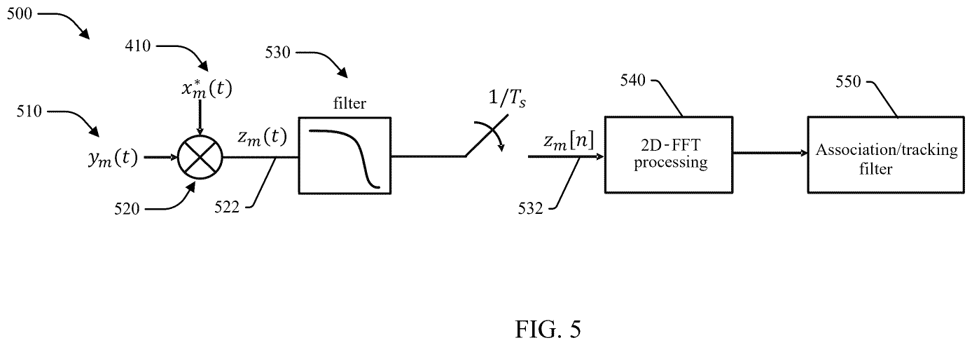

FIG. 5 is a diagram 500 of example signal processing of received radar signals. A received radar signal 510 may be received at an antenna 112 of the radar device 110. The m-th chirp of the radar signal 510 will be received at the radar as yₘ(t):=h×xₘ(t−τₘ), where h represents the propagation losses and channel attenuation, assumed constant throughout the frame duration. At mixer 520, the waveform of the received signal 510 is mixed with the waveform of the transmitted FMCW signal 410 and the mixer output 522 for the m-th chirp duration will be approximately equal to:

$${z}_{m} ( t ) := {x}_{m}^{*} ( t ) {y}_{m} ( t ) \approx h \times {e}^{- i 2 π {f}_{c} ( \frac{2 {T}_{c} v}{{c}_{0}} ) m} {e}^{- i 2 π ( \frac{B}{{T}_{up}} ) ( \frac{2 d}{{c}_{0}} ) t} ,$$

where, with a slight abuse of notation, the constant h incorporates all factors that do not depend on either

$$m or t ( h = h \times {e}^{- i 2 π {f}_{c} ( \frac{2 d}{{c}_{0}} )} ) .$$

At filter 530, the mixer output 522 is filtered (to remove broadband noise) and then sampled with a sampling frequency of Tₛ, which results in the 2D discrete-time signal 532, which may be represented as:

$${z}_{m} [ n ] := {z}_{m} ( {nT}_{s} ) = h \times {e}^{- i 2 π {f}_{c} ( \frac{2 {T}_{c} v}{{c}_{0}} ) m} {e}^{- i 2 π ( \frac{B}{{T}_{up}} ) ( \frac{2 d}{{c}_{0}} ) {T}_{s} n} ,$$

for 0≤m≤N_{c}−1, 0≤n≤N−1, where

$$N \leq \frac{{T}_{up}}{{T}_{s}}$$

is the number of samples within the upchirp interval the receiver considers per chirp. The discrete-time signal 532 is a 2D complex exponential (harmonic signal) with a (2D) frequency

$$( {f}_{c} ( \frac{2 {T}_{c} v}{{c}_{0}} ) , ( \frac{B}{{T}_{up}} ) ( \frac{2 d}{{c}_{0}} ) {T}_{s} )$$

with parameters d and v “encoded” in it.

2D-FFT processing 540 provides identification of the 2D harmonic signal (a standard estimation/detection theory problem) and also provides the target range and velocity. Typically, estimation of the 2D frequency is obtained via a 2D FFT of size Ñ_{c}≥N_{c} over the “m” dimension and size Ñ≥N over the “n” dimension. For example,

$$( {m}^{*} , {n}^{*} ) ∈ [ 0 , … , {\tilde{N}}_{c} - 1 ] \times [ - \frac{\tilde{N}}{2} - 1 , … , \frac{\tilde{N}}{2} - 1 ]$$

may denote the “bin” index of the 2D FFT with the maximum power. The range of the target may then be estimated as

$$\hat{d} = - \frac{n * {cT}_{up}}{{\tilde{N}}_{c} 2 {BT}_{s}}$$

and the velocity as

$$\hat{v} = - \frac{m * c}{\tilde{{N}_{c}} 2 {f}_{c} {T}_{c}} .$$

When multiple, say, K>1, targets are present, the 2D signal zₘ[n] includes K harmonics, that are identified via a single 2D-FFT and the range-velocity of each target is identified as above for each harmonic. The range and velocity of each target may be provided to the association/tracking filter 550 as detections.

The task of the association/tracking filter 550 is to process the time series of detections identified per frame. The association/tracking filter 550 examines the attributes of the detections (range, velocity) and groups detections in successive frames as originating from the same target. Multiple targets (tracks) can be detected. The association/tracking filter 550 will also identify new tracks (corresponding to new detections with attributes not matching current tracks) and discard tracks (due to detections with the track attributes are no longer identified). Finally, the association/tracking filter 550 will discard detections altogether (without associating them to a track) when their attributes suggest they are noise artifacts.

The different selected artificial phase ramps for two radars may allow each radar to filter out interfering signals. Assuming that the two radars follow the same FMCW parameters and having synchronous frame transmissions, radar #1 transmits frame i with a phase ramp applied using a velocity shift \tilde{v}_{i,1} and radar #2 transmits frame i with a phase ramp applied using a velocity shift\tilde{v}_{i,2}. For simplicity, the only target present for radar #1 may be assumed to be radar #2. Generalization to multiple targets and interferers is straightforward. The parameter v_{1,2} denotes the relative velocity of the two radars (assumed constant for the frame duration). The radar #1 RX will generate a 2D signal zₘ[n] that is a superposition of two harmonics: (1) From the reflection of its own transmitted signal at the target:

$${e}^{- i 2 π {f}_{c} ( \frac{2 {T}_{c} v}{{c}_{0}} ) m} {e}^{- i 2 π ( \frac{B}{{T}_{up}} ) ( \frac{2 d}{{c}_{0}} ) {T}_{s} n}$$

(e.g., signal 420) and (2) From the interferer signal:

$${e}^{- i 2 π {f}_{c} ( \frac{2 {T}_{c} ( {v}_{1 , 2} + {\tilde{v}}_{i , 2} - {\tilde{v}}_{i , 1} )}{{c}_{0}} ) m} {e}^{- i 2 π ( \frac{B}{{T}_{up}} ) ( \frac{2 d}{{c}_{0}} ) {T}_{s} n}$$

(e.g., signal 430). As radar #1 mixes the received signal (zₘ[n]) with its own signal, it cancels out the phase ramp of the target reflection (harmonic 1/signal 420). However, as the radar #1 phase ramp (velocity shift \tilde{v}_{i,1}) is different, in general, from that of radar #2 (velocity shift \tilde{v}_{i,2}), the harmonic due to the interferer signal appears as corresponding to a velocity \tilde{v}_{i,1}-\tilde{v}_{i,2}+v_{1,2} (harmonic 2/signal 430). Similarly, the effect of radar #1 to radar #2 will be a ghost target having a velocity \tilde{v}_{i,2}−\tilde{v}_{i,1}+v_{1,2}. Because \tilde{v}_{i,1} and \tilde{v}_{i,2} are chosen randomly, or according to a codebook that imparts an unrealistically changing velocity between frames, the velocity of the ghost target will appear to change dramatically and unrealistically between frames. For instance, a physical object to be detected by radar has significant mass and inertia cannot change from a positive velocity to a negative velocity within a frame on the order of a millisecond. Accordingly, the association and tracking filter may drop detections based on the interfering signal.

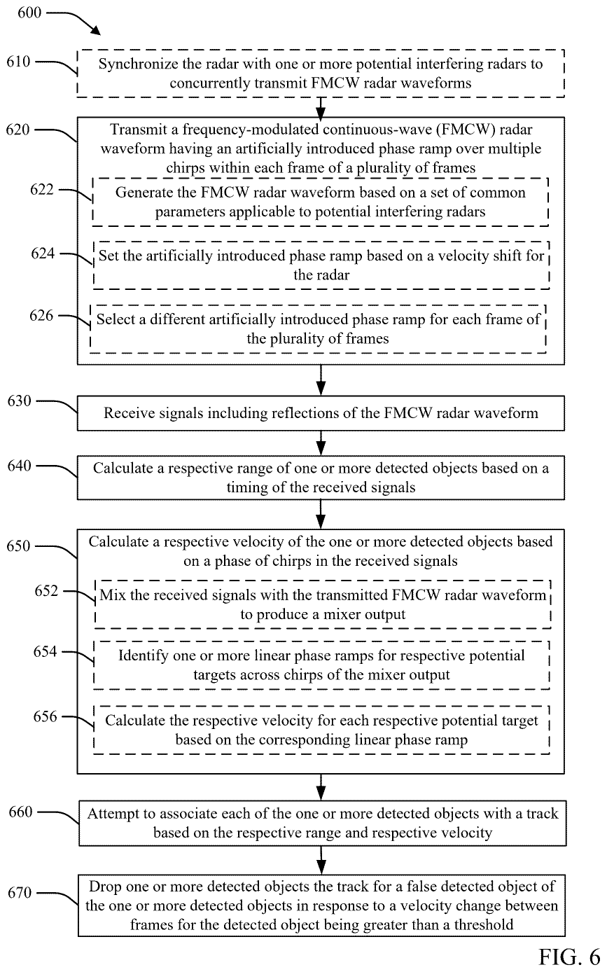

FIG. 6 is a flow diagram showing an example method 600 of operation of a radar device 110. The method 600 may be performed by the radar device 110 to detect objects 102 near the radar device 110.

At block 610, the method 600 may optionally include synchronizing the radar with one or more potential interfering radars to concurrently transmit FMCW radar waveforms. In an aspect, for example, the radar device 110 and/or the processor 114 may execute the signal generating component 130 and/or the communications component 134 to synchronize the radar device 110 with one or more potential interfering radars 180 to concurrently transmit FMCW radar waveforms. Accordingly, the radar device 110 and/or the processor 114 executing the signal generating component 130 and/or the communications component 134 may provide means for synchronizing the radar with one or more potential interfering radars to concurrently transmit FMCW radar waveforms.

At block 620, the method 600 may include transmitting a FMCW radar waveform having an artificially introduced phase ramp over multiple chirps within each frame of a plurality of frames. In an aspect, for example, the radar device 110 and/or the processor 114 may execute the signal generating component 130 and/or the phase ramp selection component 132 to transmit the FMCW radar waveform of the signal 410 having an artificially introduced phase ramp 414 over multiple chirps 210 within each frame 312 of a plurality of frames.

In an aspect, at sub-block 622, the block 620 may include generating the FMCW radar waveform of the signal 410 based on a set of common parameters applicable to potential interfering radars. For instance, the set of common parameters may include a carrier frequency, a chirp duration, and a chirp bandwidth. The use of common parameters may result in coordinated interference where interfering signals from other radars are detected as targets (e.g., ghost targets). In an aspect, at sub-block 624, the block 620 may include setting the artificially introduced phase ramp 414 based on a velocity shift for the radar device 110. For example, the artificially introduced phase ramp 414 may be based on parameters that are different for the radar device 110 than the potential interfering radars.

In an aspect, at sub-block 626, the block 620 may include selecting a different artificially introduced phase ramp for each frame of the plurality of frames. In some implementations, the sub-block 626 may include selecting the phase ramp 414 for each frame 412 based on a random velocity shift. In some implementations, the sub-block 626 may include selecting the phase ramp 414 based on a pattern specified in a codebook. The phase ramp selection component 132 may randomly select the pattern specified in the codebook, or the communications component 134 may communicate with a network or the other radars 180 to select a unique pattern specified in the codebook.

In view of the foregoing, the radar device 110 and/or the processor 114 executing the signal generating component 130 and/or the phase ramp selection component 132 may provide means for transmitting a FMCW radar waveform having an artificially introduced phase ramp over multiple chirps within each frame of a plurality of frames.

At block 630, the method 600 includes receiving signals including reflections of the FMCW radar waveform. In an aspect, for example, the radar device 110 and/or the processor 114 may execute the signal detecting component 140 to receive signals including reflections of the FMCW radar waveform (e.g., returned signal 420 and possibly interfering signal 430). Accordingly, the radar device 110 and/or the processor 114 executing the signal generating component 130 and/or the communications component 134 may provide means for receiving signals including reflections of the FMCW radar waveform.

At block 640, the method 600 includes calculating a respective range of one or more detected objects based on a timing of the received signals. In an aspect, for example, the radar device 110 and/or the processor 114 may execute the signal detecting component 140 and/or the range component 142 to calculate a respective range of one or more detected objects 102 based on a timing of the received signals. Accordingly, the radar device 110 and/or the processor 114 executing the signal detecting component 140 and/or the range component 142 may provide means for calculating a respective range of one or more detected objects based on a timing of the received signals.

At block 650, the method 600 includes calculating a respective velocity of the one or more detected objects based on a phase of chirps in the received signals. In an aspect, for example, the radar device 110 and/or the processor 114 may execute the signal detecting component 140 and/or the velocity component 144 to calculate a respective velocity of the one or more detected objects based on a phase of chirps in the received signals. In an aspect, at sub-block 652, the block 650 may include mixing (e.g., at mixer 520) the received signals (e.g., signals 420 and/or 430) with the transmitted FMCW radar waveform of signal 410 to produce a mixer output 522. In some implementations, a linear phase ramp 414 of the reflections of the FMCW radar waveform (e.g., signal 106 or signal 420) from an actual target are canceled out by the mixing. A slope of the linear phase ramp of the mixer output 522 corresponding to the actual target is proportional to the respective velocity of the actual target. In some implementations, a linear phase ramp 434 of a received signal (e.g., interfering signal 430) that is transmitted by a different radar (e.g., radar 180) does not cancel out the artificially introduced phase ramp 414 during the mixing. A slope of the linear phase ramp of the mixer output 522 corresponding to the received signal 108 that is transmitted by the different radar 180 depends on a velocity of the interfering radar, the artificially introduced phase ramp 414 of the FMCW radar waveform of signal 410, and the phase ramp 434 of the received signal 430. At sub-block 654, the block 650 may further include identifying one or more linear phase ramps for respective potential targets across chirps of the mixer output. At sub-block 656, the block 650 may include calculating the respective velocity for each respective potential target based on the corresponding linear phase ramp. The respective velocity corresponding to the received signal from the different radar may depend on an actual velocity of the different radar, a velocity shift of the artificial phase ramp of the transmitted FMCW waveform, and a velocity shift of the phase ramp of a waveform of the received signal. Accordingly, the radar device 110 and/or the processor 114 executing the signal detecting component 140 and/or the velocity component 144 may provide means for calculating a respective velocity of the one or more detected objects based on a phase of chirps in the received signals.

At block 660, the method 600 includes attempting to associate each of the one or more detected objects with a track based on the respective range and respective velocity. In an aspect, for example, the radar device 110 and/or the processor 114 may execute the association component 150 to associate each of the one or more detected objects with a track based on the respective range and respective velocity. Detected objects may be associated with the track that most closely matches the respective range and the respective velocity. For some targets, the detected object may not be associated with any track because the respective range or the respective velocity may not match any track. Such detected objects may be either a first detection or a ghost target. Accordingly, the radar device 110 and/or the processor 114 executing the association component 150 may provide means for associating each of the one or more detected objects with a track based on the respective range and respective velocity.

At block 670, the method 600 includes dropping one or more detected objects or the track for a false detected object of the one or more detected objects in response to a velocity change between frames for the detected object being greater than a threshold. In an aspect, for example, the radar device 110 and/or the processor 114 may execute the tracking component 160 to drop the track for a false detected object of the one or more detected objects in response to a velocity change between frames for the false detected object being greater than a threshold. For instance, the false detected object may be based on a signal 108 from a second radar 180 that transmits an interfering signal 430 with a second FMCW radar waveform having a different phase ramp 434. The different phase ramp results in the respective velocity changing unrealistically between frames (e.g., the velocity changes is greater than a threshold). In some implementations, the block 670 may include feeding the respective range and the respective velocity of each of the one or more detected objects to an association and tracking filter. The association and tracking filter may drop detected objects that cannot be associated with a track. The association and tracking filter may also drop a track for a false detected object when the respective velocity between frames is not realistic. For example, when the respective velocity increases rapid changes in direction that are inconsistent with movement of physical objects. Accordingly, the radar device 110 and/or the processor 114 executing the tracking component 160 may provide means for dropping one or more detected objects or the track for a false detected object of the one or more detected objects in response to a velocity change between frames for the detected object being greater than a threshold.

### Some Further Example Clauses

### Implementation Examples are Described in the Following Numbered Clauses:

1. A method of object tracking for a radar, comprising:
   transmitting a frequency-modulated continuous-wave (FMCW) radar waveform having an artificially introduced phase ramp over multiple chirps within each frame of a plurality of frames;
   receiving signals including reflections of the FMCW radar waveform;
   calculating a respective range of one or more detected objects based on a timing of the received signals;
   calculating a respective velocity of the one or more detected objects based on a phase of chirps in the received signals;
   attempting to associate each of the one or more detected objects with a track based on the respective range and the respective velocity; and
   dropping one or more detected objects or the track for a false detected object of the one or more detected objects in response to a velocity change between frames for the detected object being greater than a threshold.
2. The method of clause 1, wherein transmitting the FMCW radar waveform comprises generating the FMCW radar waveform based on a set of common parameters applicable to potential interfering radars.
3. The method of clause 2, wherein the set of common parameters includes a carrier frequency, a chirp duration, and a chirp bandwidth.
4. The method of any of clauses 1-3, wherein the false detected object is based on a signal from a second radar that transmits a second FMCW radar waveform having a different phase ramp.
5. The method of any of clauses 1-4, wherein calculating the respective velocity of one or more detected objects based on a phase of the chirps in the received signals comprises:
   mixing the received signals with the transmitted FMCW radar waveform to produce a mixer output;
   identifying one or more linear phase ramps for respective potential targets across the chirps of the mixer output; and
   calculating the respective velocity for each respective potential target based on a corresponding linear phase ramp for the respective potential target.
6. The method of clause 5, wherein a linear phase ramp of the reflections of the FMCW radar waveform from an actual target are canceled out by the mixing, wherein a slope of the linear phase ramp of the mixer output corresponding to the actual target is proportional to the respective velocity of the actual target.
7. The method of clause 5, wherein a linear phase ramp of a received signal from a different radar does not cancel out the artificially introduced phase ramp during the mixing, and wherein a slope of the linear phase ramp of the mixer output corresponding to the received signal from the different radar depends on a velocity of the different radar, the artificially introduced phase ramp of the FMCW radar waveform, and a phase ramp of the received signal.
8. The method of clause 7, where the respective velocity corresponding to the received signal from the different radar depends on an actual velocity of the different radar, a velocity shift of the artificially introduced phase ramp of the transmitted FMCW waveform, and a velocity shift of the phase ramp of the received signal.
9. The method of any of clauses 1-8, further comprising setting the artificially introduced phase ramp based on a velocity shift for the radar.
10. The method of any of clauses 1-9, wherein transmitting the FMCW radar waveform comprises selecting a different phase ramp for each frame of the plurality of frames.
11. The method of clause 10, wherein selecting the different phase ramp for each frame of the plurality of frames comprises selecting the artificially introduced phase ramp for each frame based on a random velocity shift.
12. The method of clause 10, wherein selecting the different phase ramp for each frame of the plurality of frames comprises selecting the artificially introduced phase ramp based on a pattern specified in a codebook.
13. The method of any of clauses 1-12, further comprising synchronizing the radar with one or more potential interfering radars to concurrently transmit FMCW radar waveforms.
14. The method of any of clauses 1-13 wherein dropping the one or more detected objects or the track for the false detected object of the one or more detected objects comprises feeding the respective range and the respective velocity of each of the one or more detected objects to an association and tracking filter.
15. A radar, comprising:
   one or more antennas;
   a memory storing executable instructions; and
   at least one processor communicatively coupled with the one or more antennas and with the memory, the processor configured to:
   transmit, via the one or more antennas, a frequency-modulated continuous-wave (FMCW) radar waveform having an artificially introduced phase ramp over multiple chirps within each frame of a plurality of frames;
   receive, via the one or more antennas, signals including reflections of the FMCW radar waveform;
   calculate a respective range of one or more detected objects based on a timing of the received signals;
   calculate a respective velocity of the one or more detected objects based on a phase of chirps in the received signals;
   attempt to associate each of the one or more detected objects with a track based on the respective range and the respective velocity; and
   drop one or more detected objects or the track for a false detected object of the one or more detected objects in response to a velocity change between frames for the detected object being greater than a threshold.
16. The radar of clause 15, wherein the at least one processor is configured to generate the FMCW radar waveform based on a set of common parameters applicable to potential interfering radars.
17. The radar of clause 16, wherein the set of common parameters includes a carrier frequency, a chirp duration, and a chirp bandwidth.
18. The radar of any of clauses 15-17, wherein the false detected object is based on a signal from a second radar that transmits a second FMCW radar waveform having a different phase ramp.
19. The radar of any of clauses 15-18, wherein the at least one processor is configured to:
   mix the received signals with the transmitted FMCW radar waveform to produce a mixer output;
   identify one or more linear phase ramps for respective potential targets across the chirps of the mixer output; and
   calculate the respective velocity for each respective potential target based on a corresponding linear phase ramp for the respective potential target.
20. The radar of clause 19, wherein a linear phase ramp of the reflections of the FMCW radar waveform from an actual target are canceled out by the mixing, wherein a slope of the linear phase ramp of the mixer output corresponding to the actual target is proportional to the respective velocity of the actual target.
21. The radar of clause 19, wherein a linear phase ramp of a received signal from a different radar does not cancel out the artificially introduced phase ramp during the mixing, and wherein a slope of the linear phase ramp of the mixer output corresponding to the received signal from the different radar depends on a velocity of the different radar, the artificially introduced phase ramp of the FMCW radar waveform, and a phase ramp of the received signal.
22. The radar of clause 21, where the respective velocity corresponding to the received signal from the different radar depends on an actual velocity of the different radar, a velocity shift of the artificially introduced phase ramp of the transmitted FMCW waveform, and a velocity shift of the phase ramp of the received signal.
23. The radar of any of clauses 15-22, wherein the at least one processor is configured to set the artificially introduced phase ramp based on a velocity shift for the radar.
24. The radar of any of clauses 15-23, wherein the at least one processor is configured to select a different phase ramp for each frame of the plurality of frames.
25. The radar of clause 24, wherein the at least one processor is configured to select the artificially introduced phase ramp for each frame based on a random velocity shift.
26. The radar of clause 24, wherein the at least one processor is configured to select the artificially introduced phase ramp based on a pattern specified in a codebook.
27. The radar of any of clauses 15-26, wherein the at least one processor is configured to synchronize the radar with one or more potential interfering radars to concurrently transmit FMCW radar waveforms.
28. The radar of any of clauses 15-26, wherein the at least one processor is configured to feed the respective range and the respective velocity of each of the one or more detected objects to an association and tracking filter.
29. A radar, comprising:
   means for transmitting a frequency-modulated continuous-wave (FMCW) radar waveform having an artificially introduced phase ramp over multiple chirps within each frame of a plurality of frames;
   means for receiving signals including reflections of the FMCW radar waveform;
   means for calculating a respective range of one or more detected objects based on a timing of the received signals;
   means for calculating a respective velocity of the one or more detected objects based on a phase of chirps in the received signals;
   means for attempting to associate each of the one or more detected objects with a track based on the respective range and the respective velocity; and
   means for dropping one or more detected objects or the track for a false detected object of the one or more detected objects in response to a velocity change between frames for the detected object being greater than a threshold.
30. The radar of clause 29, wherein the means for transmitting the FMCW radar waveform is configured to generate the FMCW radar waveform based on a set of common parameters applicable to potential interfering radars.
31. The radar of clause 30, wherein the set of common parameters includes a carrier frequency, a chirp duration, and a chirp bandwidth.
32. The radar of any of clauses 29-31, wherein the false detected object is based on a signal from a second radar that transmits a second FMCW radar waveform having a different phase ramp.
33. The radar of any of clauses 29-32, wherein the means for calculating the respective velocity of one or more detected objects based on a phase of the chirps in the received signals is configured to:
   mix the received signals with the transmitted FMCW radar waveform to produce a mixer output;
   identify one or more linear phase ramps for respective potential targets across the chirps of the mixer output; and
   calculate the respective velocity for each respective potential target based on a corresponding linear phase ramp for the respective potential target.
34. The radar of clause 33, wherein a linear phase ramp of the reflections of the FMCW radar waveform from an actual target are canceled out by the mixing, wherein a slope of the linear phase ramp of the mixer output corresponding to the actual target is proportional to the respective velocity of the actual target.
35. The radar of clause 33, wherein a linear phase ramp of a received signal from a different radar does not cancel out the artificially introduced phase ramp during the mixing, and wherein a slope of the linear phase ramp of the mixer output corresponding to the received signal from the different radar depends on a velocity of the different radar, the artificially introduced phase ramp of the FMCW radar waveform, and a phase ramp of the received signal.
36. The radar of clause 35, where the respective velocity corresponding to the received signal from the different radar depends on an actual velocity of the different radar, a velocity shift of the artificially introduced phase ramp of the transmitted FMCW waveform, and a velocity shift of the phase ramp of the received signal.
37. The radar of any of clauses 29-36, further comprising means for setting the artificially introduced phase ramp based on a velocity shift for the radar.
38. The radar of any of clauses 29-37, wherein the means for transmitting the FMCW radar waveform is configured to select a different phase ramp for each frame of the plurality of frames.
39. The radar of clause 38, wherein selecting the different phase ramp for each frame of the plurality of frames comprises selecting the artificially introduced phase ramp for each frame based on a random velocity shift.
40. The radar of clause 38, wherein the means for transmitting the FMCW radar waveform is configured to select the artificially introduced phase ramp based on a pattern specified in a codebook.
41. The radar of any of clauses 29-40, further comprising means for synchronizing the radar with one or more potential interfering radars to concurrently transmit FMCW radar waveforms.
42. The radar of any of clauses 29-41, wherein the means for dropping the one or more detected objects or the track for the false detected object of the one or more detected objects is configured to feed the respective range and the respective velocity of each of the one or more detected objects to an association and tracking filter.
43. A non-transitory computer-readable medium storing computer executable code that when executed by a processor of a radar causes the processor to:
   transmit a frequency-modulated continuous-wave (FMCW) radar waveform having an artificially introduced phase ramp over multiple chirps within each frame of a plurality of frames;
   receive signals including reflections of the FMCW radar waveform;
   calculate a respective range of one or more detected objects based on a timing of the received signals;
   calculate a respective velocity of the one or more detected objects based on a phase of chirps in the received signals;
   attempt to associate each of the one or more detected objects with a track based on the respective range and the respective velocity; and
   drop one or more detected objects or the track for a false detected object of the one or more detected objects in response to a velocity change between frames for the detected object being greater than a threshold.
44. The non-transitory computer-readable medium of clause 43, wherein the code to transmit the FMCW radar waveform comprises code to generate the FMCW radar waveform based on a set of common parameters applicable to potential interfering radars.
45. The non-transitory computer-readable medium of clause 44, wherein the set of common parameters includes a carrier frequency, a chirp duration, and a chirp bandwidth.
46. The non-transitory computer-readable medium of any of clauses 43-45, wherein the false detected object is based on a signal from a second radar that transmits a second FMCW radar waveform having a different phase ramp.
47. The non-transitory computer-readable medium of any of clauses 43-46, wherein the code to calculate the respective velocity of one or more detected objects based on a phase of the chirps in the received signals comprises code to:
   mix the received signals with the transmitted FMCW radar waveform to produce a mixer output;
   identify one or more linear phase ramps for respective potential targets across the chirps of the mixer output; and
   calculate the respective velocity for each respective potential target based on a corresponding linear phase ramp for the respective potential target.
48. The non-transitory computer-readable medium of clause 47, wherein a linear phase ramp of the reflections of the FMCW radar waveform from an actual target are canceled out by the mixing, wherein a slope of the linear phase ramp of the mixer output corresponding to the actual target is proportional to the respective velocity of the actual target.
49. The non-transitory computer-readable medium of clause 47, wherein a linear phase ramp of a received signal from a different radar does not cancel out the artificially introduced phase ramp during the mixing, and wherein a slope of the linear phase ramp of the mixer output corresponding to the received signal from the different radar depends on a velocity of the different radar, the artificially introduced phase ramp of the FMCW radar waveform, and a phase ramp of the received signal.
50. The non-transitory computer-readable medium of clause 49, where the respective velocity corresponding to the received signal from the different radar depends on an actual velocity of the different radar, a velocity shift of the artificially introduced phase ramp of the transmitted FMCW waveform, and a velocity shift of the phase ramp of the received signal.
51. The non-transitory computer-readable medium of any of clauses 43-50, further comprising code to set the artificially introduced phase ramp based on a velocity shift for the radar.
52. The non-transitory computer-readable medium of any of clauses 43-51, wherein the code to transmit the FMCW radar waveform comprises code to select a different phase ramp for each frame of the plurality of frames.
53. The non-transitory computer-readable medium of clause 52, wherein the code to select the different phase ramp for each frame of the plurality of frames comprises code to select the artificially introduced phase ramp for each frame based on a random velocity shift.
54. The non-transitory computer-readable medium of clause 52, wherein the code to select the different phase ramp for each frame of the plurality of frames comprises code to select the artificially introduced phase ramp based on a pattern specified in a codebook.
55. The non-transitory computer-readable medium of any of clauses 43-54, further comprising code to synchronize the radar with one or more potential interfering radars to concurrently transmit FMCW radar waveforms.
56. The non-transitory computer-readable medium of any of clauses 43-55, wherein the code to drop the one or more detected objects or the track for the false detected object of the one or more detected objects comprises code to feed the respective range and the respective velocity of each of the one or more detected objects to an association and tracking filter.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. A method of object tracking for a radar, comprising:
transmitting a frequency-modulated continuous-wave (FMCW) radar waveform having an artificially introduced phase ramp over multiple chirps within each frame of a plurality of frames;
receiving signals including reflections of the FMCW radar waveform;
calculating a respective range of one or more detected objects based on a timing of the received signals;
calculating a respective velocity of the one or more detected objects based on a phase of chirps in the received signals;
attempting to associate each of the one or more detected objects with a track based on the respective range and the respective velocity; and
dropping one or more detected objects or the track for a false detected object of the one or more detected objects in response to a velocity change between frames for the detected object being greater than a threshold.

2. The method of claim 1, wherein transmitting the FMCW radar waveform comprises generating the FMCW radar waveform based on a set of common parameters applicable to potential interfering radars, the set of common parameters including a carrier frequency, a chirp duration, and a chirp bandwidth.

3. (canceled)

4. (canceled)

5. The method of claim 1, wherein calculating the respective velocity of one or more detected objects based on a phase of the chirps in the received signals comprises:
mixing the received signals with the transmitted FMCW radar waveform to produce a mixer output;
identifying one or more linear phase ramps for respective potential targets across the chirps of the mixer output; and
calculating the respective velocity for each respective potential target based on a corresponding linear phase ramp for the respective potential target.

6. The method of claim 5, wherein:
a linear phase ramp of the reflections of the FMCW radar waveform from an actual target are canceled out by the mixing, wherein a slope of the linear phase ramp of the mixer output corresponding to the actual target is proportional to the respective velocity of the actual target, and
the linear phase ramp of a received signal from a different radar does not cancel out the artificially introduced phase ramp during the mixing, and wherein the slope of the linear phase ramp of the mixer output corresponding to the received signal from the different radar depends on a velocity of the different radar, the artificially introduced phase ramp of the FMCW radar waveform, and a phase ramp of the received signal.

7. (canceled)

8. The method of claim 6, where the respective velocity corresponding to the received signal from the different radar depends on an actual velocity of the different radar, a velocity shift of the artificially introduced phase ramp of the transmitted FMCW waveform, and a velocity shift of the phase ramp of the received signal.

9. The method of claim 1, further comprising setting the artificially introduced phase ramp based on a velocity shift for the radar.

10. The method of claim 1, wherein transmitting the FMCW radar waveform comprises selecting a different phase ramp for each frame of the plurality of frames.

11. The method of claim 10, wherein selecting the different phase ramp for each frame of the plurality of frames comprises:
selecting the artificially introduced phase ramp for each frame based on a random velocity shift, or
selecting the artificially introduced phase ramp based on a pattern specified in a codebook.

12. (canceled)

13. The method of claim 1, further comprising synchronizing the radar with one or more potential interfering radars to concurrently transmit FMCW radar waveforms.

14. (canceled)

15. A radar, comprising:
one or more antennas;
a memory storing executable instructions; and
at least one processor communicatively coupled with the one or more antennas and with the memory, the processor configured to:
transmit, via the one or more antennas, a frequency-modulated continuous-wave (FMCW) radar waveform having an artificially introduced phase ramp over multiple chirps within each frame of a plurality of frames;
receive, via the one or more antennas, signals including reflections of the FMCW radar waveform;
calculate a respective range of one or more detected objects based on a timing of the received signals;
calculate a respective velocity of the one or more detected objects based on a phase of chirps in the received signals;
attempt to associate each of the one or more detected objects with a track based on the respective range and the respective velocity; and
drop one or more detected objects or the track for a false detected object of the one or more detected objects in response to a velocity change between frames for the detected object being greater than a threshold.

16. The radar of claim 15, wherein the at least one processor is configured to generate the FMCW radar waveform based on a set of common parameters applicable to potential interfering radars, the set of common parameters including a carrier frequency, a chirp duration, and a chirp bandwidth.

17. (canceled)

18. (canceled)

19. The radar of claim 15, wherein the at least one processor is configured to:
mix the received signals with the transmitted FMCW radar waveform to produce a mixer output;
identify one or more linear phase ramps for respective potential targets across the chirps of the mixer output; and
calculate the respective velocity for each respective potential target based on a corresponding linear phase ramp for the respective potential target.

20. The radar of claim 19, wherein:
a linear phase ramp of the reflections of the FMCW radar waveform from an actual target are canceled out by the mixing, wherein a slope of the linear phase ramp of the mixer output corresponding to the actual target is proportional to the respective velocity of the actual target; and
the linear phase ramp of a received signal from a different radar does not cancel out the artificially introduced phase ramp during the mixing, and wherein the slope of the linear phase ramp of the mixer output corresponding to the received signal from the different radar depends on a velocity of the different radar, the artificially introduced phase ramp of the FMCW radar waveform, and a phase ramp of the received signal.

21. (canceled)

22. The radar of claim 20, where the respective velocity corresponding to the received signal from the different radar depends on an actual velocity of the different radar, a velocity shift of the artificially introduced phase ramp of the transmitted FMCW waveform, and a velocity shift of the phase ramp of the received signal.

23. The radar of claim 15, wherein the at least one processor is configured to set the artificially introduced phase ramp based on a velocity shift for the radar.

24. The radar of claim 15, wherein the at least one processor is configured to select a different phase ramp for each frame of the plurality of frames.

25. The radar of claim 24, wherein the at least one processor is configured to;
select the artificially introduced phase ramp for each frame based on a random velocity shift, or
select the artificially introduced phase ramp based on a pattern specified in a codebook.

26. (canceled)

27. The radar of claim 15, wherein the at least one processor is configured to synchronize the radar with one or more potential interfering radars to concurrently transmit FMCW radar waveforms.

28. The radar of claim 15, wherein the at least one processor is configured to feed the respective range and the respective velocity of each of the one or more detected objects to an association and tracking filter.

29. A radar, comprising:
means for transmitting a frequency-modulated continuous-wave (FMCW) radar waveform having an artificially introduced phase ramp over multiple chirps within each frame of a plurality of frames;
means for receiving signals including reflections of the FMCW radar waveform;
means for calculating a respective range of one or more detected objects based on a timing of the received signals;
means for calculating a respective velocity of the one or more detected objects based on a phase of chirps in the received signals;
means for attempting to associate each of the one or more detected objects with a track based on the respective range and the respective velocity; and means for dropping one or more detected objects or the track for a false detected object of the one or more detected objects in response to a velocity change between frames for the detected object being greater than a threshold.

30. (canceled)
